(19) United States
(12) Patent Application Publication
(10) Pub. No.: US 2024/0283208 A1
(43) Pub. Date: Aug. 22, 2024

(54) Connector, Connector Assembly, and a Tool and Method for Assembling the Connector Assembly

(71) Applicant: ERNI International AG, Schaffhausen (CH)

(72) Inventors: Kai-Rene Semilia, Bad Ditzenbach (DE); Sebastian Gavanda, Weinstadt (DE); Fabian Kristmann, Ebersbach (DE); Kurt Ziegele, Schorndorf (DE); Stephen Kaminski, Salach (DE)

(73) Assignee: ERNI International AG, Schaffhausen (CH)

(21) Appl. No.: 18/654,252

(22) Filed: May 3, 2024

Related U.S. Application Data
(63) Continuation of application No. PCT/EP2022/080536, filed on Nov. 2, 2022.

(30) Foreign Application Priority Data
Nov. 5, 2021 (DE) 10 2021 128 871.1

(51) Int. Cl. H01R 43/20; H01R 13/502

(52) U.S. Cl. CPC H01R 43/20; H01R 13/502

(57) ABSTRACT

A plug connector includes a first housing part having a plug contact element with a plurality of blades that are electrically conductively connected and a second housing part having a receiving area receiving a conductor foil. The second housing part has a first ridge pressing the conductor foil in the receiving area in a direction of the blades while the first housing part and the second housing part are pushed into each other. The first ridge engages in a fit with a first blade of the plurality of blades when a first area of the first blade is bent in a direction of the first ridge.

### CROSS-REFERENCE TO RELATED APPLICATIONS

This application is a continuation of PCT International Application No. PCT/EP2022/080536, filed on Nov. 2, 2022, which claims priority under 35 U.S.C. § 119 to German Patent Application No. 102021128871.1, filed on Nov. 5, 2021.

### FIELD OF THE INVENTION

The present invention relates to a plug connector for a flexible conductor foil. Moreover, the present invention relates to a plug connector assembly, which has the plug connector, as well as a tool and a method for assembling the plug connector assembly.

### BACKGROUND

Flexible conductor foils with foil-insulated conductors are today used in different areas of entertainment and consumer electronics, but also in vehicle construction. Conductor foils in particular come into use there where a very flexible conductor structure is desired, with the lowest possible weight and restricted spatial requirements. Flexible conductor foils allow an ordered parallel routing of a plurality of separated conductor paths, wherein larger bends are also possible and parts can thus be electrically conductively connected with each other, that are arranged in an only very restricted installation space. In particular in vehicle construction, conductor foils of this type must also be able to withstand large mechanical influences, for example such as vibrations.

Thus, the contacting of the individual foil-insulated conductors gains a particular significance. Particularly in vehicle construction, this contacting must be configured to be secure and resistant to external mechanical influences, but also to temperature influences and environmental influences of different types.

DE 10 2015 100 401 B4 describes a plug connector for flexible conductor foils including foil insulated conductors having a plug connector housing in which at least one plug contact element is arranged. In one connection area, blades that are electrically conductively connected with the at least one plug contact element can penetrate and fix at least one foil insulated conductor during the production of an electric contact. The plug connector housing comprises two housing parts that can slide into each other. The first housing part stores the blades and the at least one plug contact element that is electrically conductively connected. The second housing part takes up and stores the flexible conductor foil. Moreover, the second housing part has at least one blade receiver that is matched to the blades, the boundary faces of which are formed in such a way that at least some of the blades are bent in the direction of the foil-insulated conductor during the pushing-in of the two housing parts. By bending the blades, a pressure is exerted on the contact faces between the blades and conductor foil, so that the electric contact faces are enlarged. Simultaneously, the blades are kept under a certain tension in the plug connector housing. In this way, an electrically good and gas-tight contacting can be achieved in the plug connector.

With the blades being bent at the point at which they protrude from a male connector and thus being angled across their entire length towards the male connector, at the contact point between the conductor foil and blades, a constant mechanical load is exerted on the conductor foil. Particularly, if the plug connector is continually exposed to vibrations during its use in automotive engineering, this could lead to damage to the conductor foil. The pressure that is exerted on the boundary faces of the second housing part via the bent blades could additionally cause a detachment of the first housing part from the second housing part, due to the impact of vibrations.

### SUMMARY

A plug connector includes a first housing part having a plug contact element with a plurality of blades that are electrically conductively connected and a second housing part having a receiving area receiving a conductor foil. The second housing part has a first ridge pressing the conductor foil in the receiving area in a direction of the blades while the first housing part and the second housing part are pushed into each other. The first ridge engages in a fit with a first blade of the plurality of blades when a first area of the first blade is bent in a direction of the first ridge.

### BRIEF DESCRIPTION OF THE DRAWINGS

Exemplary embodiments of the invention are represented in the drawings and are described in more detail in the following description:

FIG. 1a shows components of a plug connector assembly according to an exemplary embodiment of the invention in a first assembly step in an isometric view;

FIG. 1b shows components of a plug connector assembly according to an exemplary embodiment of the invention in a first assembly step in a cutaway isometric view;

FIG. 1c shows components of a plug connector assembly according to an exemplary embodiment of the invention in a first assembly step in a cutaway side view;

FIG. 2a shows a plug connector assembly according to an exemplary embodiment of the invention in a second assembly step in an isometric view;

FIG. 2b shows a plug connector assembly according to an exemplary embodiment of the invention in a second assembly step in a cutaway isometric view;

FIG. 2c shows a plug connector assembly according to an exemplary embodiment of the invention in a second assembly step in a cutaway side view;

FIG. 3a shows a plug connector assembly according to an exemplary embodiment of the invention in a third assembly step in an isometric view;

FIG. 3b shows a plug connector assembly according to an exemplary embodiment of the invention in a third assembly step in a cutaway isometric view;

FIG. 3c shows a plug connector assembly according to an exemplary embodiment of the invention in a third assembly step in a cutaway side view;

FIG. 4 shows an exemplary embodiment of a tool according to the invention;

FIG. 5 shows another exemplary embodiment of a tool according to the invention;

FIG. 6a shows a tool and a plug connector assembly according to an exemplary embodiment of the invention in a second assembly step in an isometric view;

FIG. 6b shows a tool and a plug connector assembly according to an exemplary embodiment of the invention in a second assembly step in a cutaway isometric view;

FIG. 6c shows a tool and a plug connector assembly according to an exemplary embodiment of the invention in a second assembly step in a cutaway side view;

FIG. 7a shows a tool and a plug connector assembly according to an exemplary embodiment of the invention in a third assembly step in an isometric view;

FIG. 7b shows a tool and a plug connector assembly according to an exemplary embodiment of the invention in a third assembly step in a cutaway isometric view;

FIG. 7c shows a tool and a plug connector assembly according to an exemplary embodiment of the invention in a cutaway side view;

FIG. 8 shows a plug connector assembly according to another exemplary embodiment of the invention in a second assembly step in a cutaway side view;

FIG. 9 shows a plug connector assembly according to another exemplary embodiment of the invention in a third assembly step in a cutaway side view;

FIG. 10 shows a plug connector assembly according to another exemplary embodiment of the invention in a second assembly step in a cutaway side view;

FIG. 11 shows a plug connector assembly according to another exemplary embodiment of the invention in a third assembly step in a cutaway side view;

FIG. 12 shows a plug connector assembly according to another exemplary embodiment of the invention in a second assembly step in a cutaway side view;

FIG. 13 shows a plug connector assembly according to another exemplary embodiment of the invention in a third assembly step in a cutaway side view;

FIG. 14 shows a plug connector assembly according to another exemplary embodiment of the invention in a second assembly step in a cutaway side view;

FIG. 15 shows a plug connector assembly according to another exemplary embodiment of the invention in a third assembly step in a cutaway side view;

FIG. 16 shows a plug connector assembly according to another exemplary embodiment of the invention in a second assembly step in a cutaway side view; and

FIG. 17 shows a plug connector assembly according to another exemplary embodiment of the invention in a third assembly step in a cutaway side view.

### DETAILED DESCRIPTION OF THE EMBODIMENT(S)

In the following, the invention will be described in greater detail and in an exemplary manner using embodiments and with reference to the drawings. The described embodiments are only possible configurations in which, however, the individual features as described herein can be provided independently of one another or can be omitted.

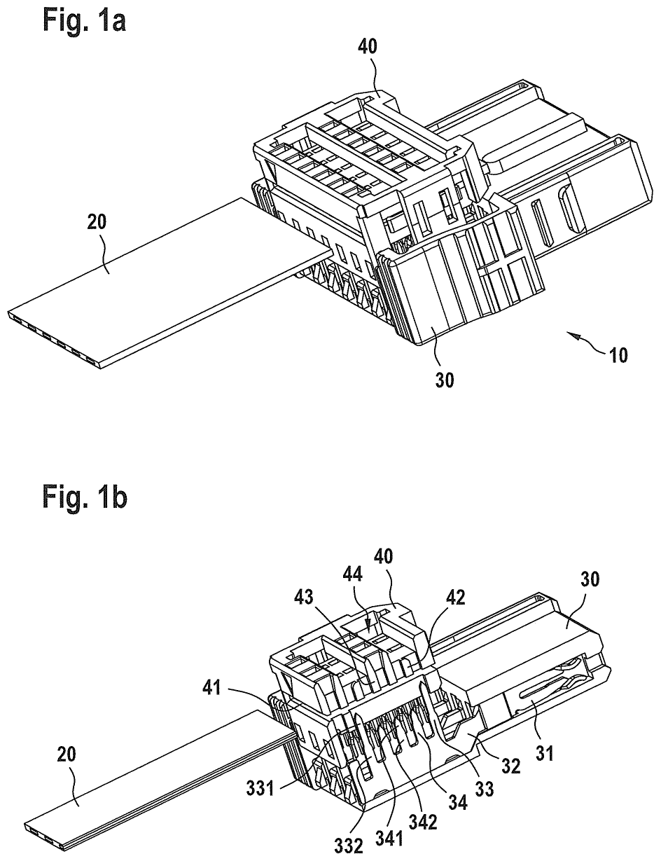

In FIGS. 1a to 1c, a first assembly step of a plug connector assembly according to a first exemplary embodiment of the invention is shown. A plug connector 10 and a flat flexible conductor foil 20 with foil-insulated conductors are provided.

The plug connector 10 has a first housing part 30 and a second housing part 40. Several plug contact elements 31, which are configured as spring elements, are arranged in the first housing part 30, as shown in FIG. 1b. Each plug contact element 31 is electrically conductively connected with two first blades 33 and three second blades 34 that are arranged between the two first blades 33 over a row 32 of blades, which is configured as a cutting edge. The first blades 33 are longer than the second blades 34. Each of the blades 33, 34 respectively has a first area 331, 341, which faces away from the row 32, and a second area 332, 342, that faces towards the row 32. Every first area 331, 341 is narrower than the respective second area 332, 342. The second housing part 40 has a receiving area 41 for the conductor foil 20. This receiving area 41 is widened towards the outside of the plug connector 10 in a funnel shape, in order to facilitate the insertion of the conductor foil 20.

Two first ridges 42, shown in FIGS. 1b and 1c, are arranged in such a way that they each come to rest between a first blade 33 and a second blade 34 during the pushing-in of the two housing parts 30, 40. The first ridges 42 can alternatively be referred to as the first ribs 42. On their sides that face away from the first housing part 30, they each have a face, the contour of which is curved in a circular arc from the first blade 33 to the second blade 34. Furthermore, the second housing part 40 has two second ridges 43. The second ridges 43 can also be referred to as a second rib 43. These are arranged in such a way that they each come to rest between two second blades 34 during the pushing-in of the housing parts 30, 40. Two openings 44 in the top of the second housing part 40 respectively enable access to a row of first ridges 42, which runs perpendicular to a row 32 of blades 33, 34. Every opening 44 thus also enables access to the first blades 32, which respectively run along the first ridges 42 during the pushing-in of the two housing parts 30, 40. The opening 44 makes it possible to exert a force on the first blades 33 of the first housing part 30 from the side of the second housing part 40 that faces away from the first housing part 30, by the tool 50 described below, in order to bend these blades 33.

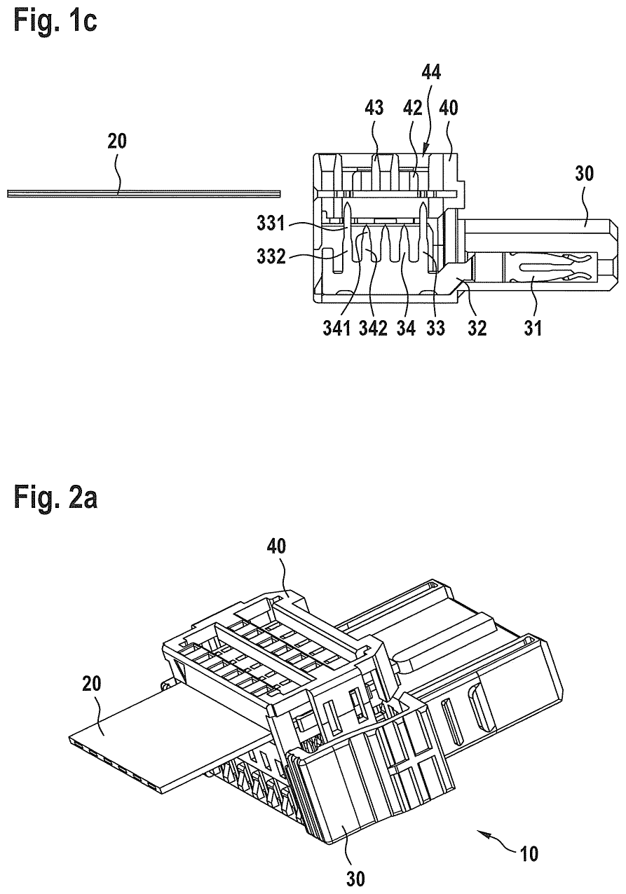

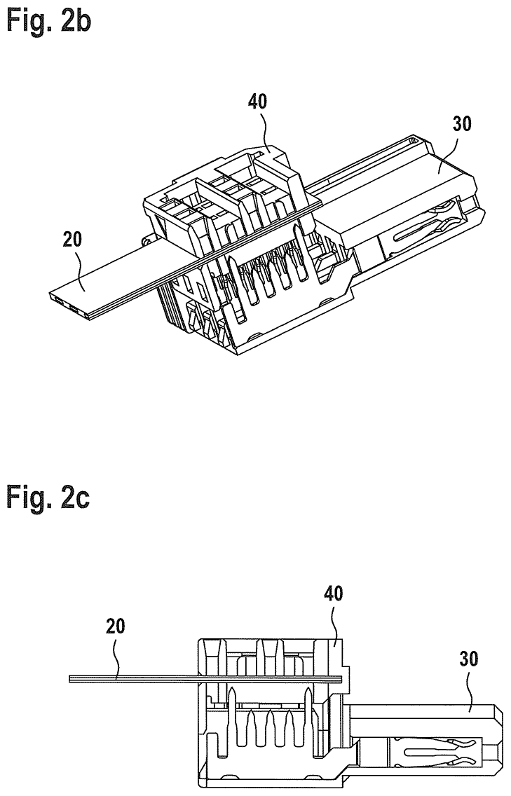

In a second assembly step, which is shown in FIGS. 2a to 2c, the conductor foil 20 is pushed into the receiving area 41 of the plug connector 10, so that it is mounted in the receiving area 41. Each conductor of the conductor foil 20 thereby comes to rest over a row 32 of blades 33, 34. The second ridge 43 presses the conductor foil 20 that is arranged in the receiving area 41 in the direction of the blades 33, 34 during the pushing-in of the housing parts 30, 40. Thus, every second ridge 43 thereby supports the first ridges 42 to fix the conductor foil 20 in its position.

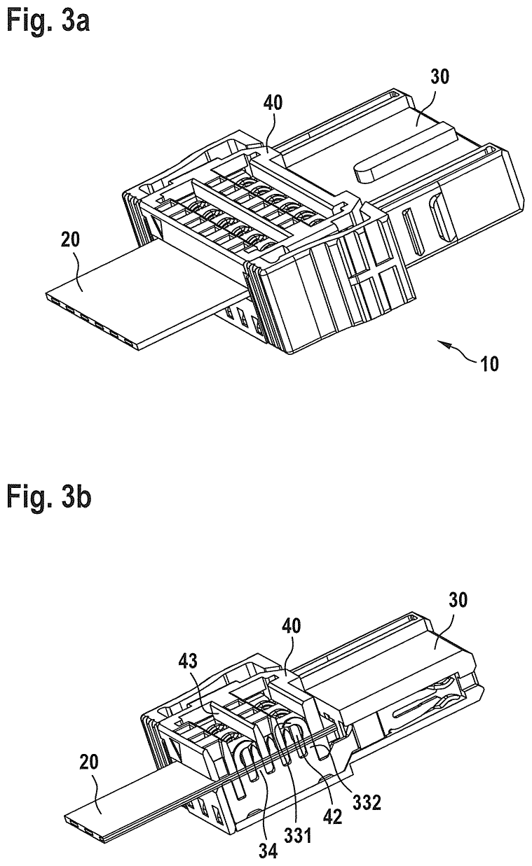

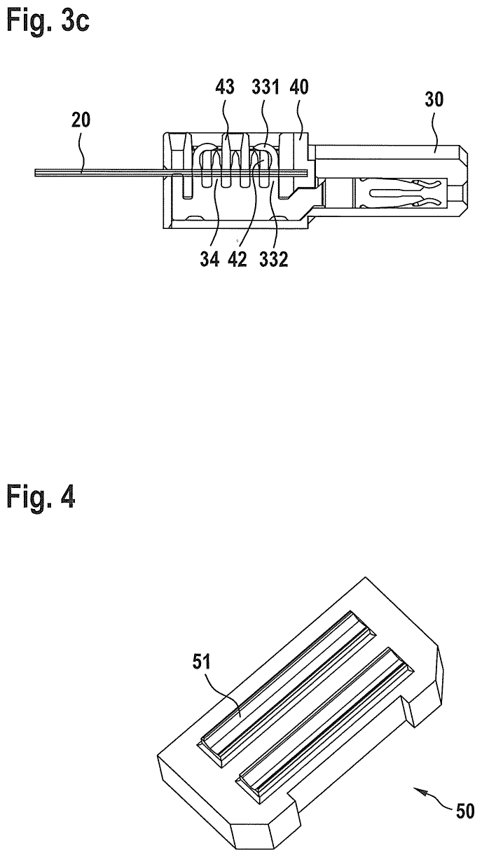

In FIGS. 3a to 3c, it is shown how the two housing parts 30, 40 are pushed together in a third assembly step. The first ridge 42 and second ridge 43 thereby press the conductor foil 20 onto the blades 33, 34, which firstly intersect the conductor foil with their first areas 331, 341 and then with their second areas 332, 342. The conductor foil 20 comes to rest on the second areas 332, 342 of the blades 33, 34. The second areas 332, 342 are not intended to be bent. All first ridges 42 and all potentially available second ridges 43 may be sliding surfaces for the blades 33, 34.

Finally, the ridges 42, 43 fix the conductor foil 20 in its intended final position. The first areas 331 of the first blades 33 are bent in a circular arc by at least 80°, or 90° in the direction of their respective first ridge 42, until they come to rest in a tight fit on the curved face of the first ridge 42. The tips of both bent first blades 33 point to each other. It is thus no longer possible to move the two housing parts 30, 40 out of each other. A loosening of the ridges 42, 43 from the conductor foil 20 is thereby prevented, so that the plug connector 10 engages in a lasting, gas-tight connection with the conductor foil 20.

Even if the plug connector 10 is exposed to high mechanical loads, the bent area of the first blade 33 securely holds the first ridge 42 in its position and this, in its turn, secures the position of the conductor foil 10. An occurrence of leaks in the plug connector 10 is thus reliably prevented. Since the second area 332, 342 of the first blade 33 is not bent, no forces act on the contact area between the second area 332, 342 of the first blade 33 and the conductor foil 10 when at rest. Vibrations can thus also be tolerated, without the first blade 33 undesirably carving further into the flexible conductor foil, which could lead to a degradation of the electrical contacting by the end of the vibrations.

While the first blade 33 is intended to be bent in its first area 331, 341 in order to engage in a tight fit with a first ridge 42, the second blade 34 solely serves to intersect the conductor foil 10 and to electrically contact it. By arranging several first blades 33 and second blades 34 in a row behind each other, a conductor 10 of the conductor foil can be intersected at several places, in order to ensure such a redundant electrical contacting of the conductor 10 with the plug contact element 31.

By the arrangement of the first blades 33 on the two ends of the row 32, they can achieve an especially consistent mechanical connection between the first housing part and the second housing part. In this case, the first area 331, 341 of every first blade 33 is bent in the direction of a second blade 34. This allows the bending of the first blade 33, without creating a need for an additional space along the first row 32. Thus, the first blades 33 can be bent over the second blades 34, since they are longer than the second blades 34. If the plug connector 10 has at least one first blade 33 and at least one second blade 34, then the end of the bent first blade 33 is in particular positioned over the end of a second blade 34.

In one embodiment of the invention there are two first blades 33 and two second blades 34 in each row. In another embodiment of the invention there are two first blades 33 and three second blades 34 in each row. Every first ridge 42 is, to this end, arranged between a first blade 33 and a second blade 34. If the first area 331, 341 of a first blade 33 is then bent in the direction of a second blade 34, it comes to rest on the first ridge 42 and engages in a tight fit with this. It thereby presses on this from the side of the first ridge 42 that faces the second housing part 40 and thus reliably prevents the first ridge 42 moving away from the first housing part 30 and with it from the conductor foil 10.

The first area 331, 341 of the first blade 33, in an embodiment, has a smaller width than its second area 34. Due to the change in width of the first blade 33 and the pre-centering in the first area 331, 341 that is connected with this, a lasting, stable contacting of the conductor in the second area 332, 342 can be ensured.

Furthermore, this causes a strain relief via the geometry located at the contact, which causes a clamping of the foil conductor 20 in the mounted state of the plug connector 10. Simultaneously, a bending of the first blade 33 in its first area is simplified by the fact that its width is only small. In principle, a geometry with two different widths can also be provided for the two blades 33, 34, in order to improve the contacting in the area of the higher width. A bending of the two blades 33, 34 in the narrower area is, however, not provided. The transition from one width to the next width can be carried out both as a step and as a continual transition. In principle, still further areas with a still larger width can also be provided in addition to the first two areas. The width of the areas thus increases steadily from the first area, which faces the second housing part, up to the further areas.

The width of the conductor foil 20 in particular essentially corresponds to the width of the receiving area 41. The conductor foil 20 is arranged in the receiving area 41 of the plug connector in such a way that it is intersected by at least one blade 33, 34. In this case, this is at least one first blade 33. If, however, the plug connector 10 also has second blades 34, the conductor foil 20 is also intersected by this. The conductor foil 20 is pressed into the plug connector assembly in the direction of the first housing part 30 by at least one first ridge 42. If the plug connector 10 has second ridges 43, then the conductor foil 20 is also pressed in the direction of the first housing part 30 by these. A first blade 33 lies in a tight fit on every first ridge 42 and presses this in the direction of the conductor foil 20.

A first exemplary embodiment of a tool 50 for bending the first area 331 of the first blade 33 is shown in FIG. 4. It has two concave bending areas 51 with circular-arc contours, which protrude from the main body of the tool 50. These correspond to the shape in which the first areas 331 of the first blades 33 should be bent, and also match with the surface curvature of the first ridge 42. The tool 50 is designed in such a way that it can be mounted on the second housing part 40. Every bending area 51 thus engages in one of the openings 44. In this way, the tool 50 can exert a force on the first areas 331 of the first blades 33 that protrude over the first ridge 42, and bend these in the direction of the first ridge 42.

In principle, it is possible for all first ridges 42 that can be reached through a common opening in the second housing part 40 of the plug connector 10 to provide a single collective concave bending area 51. However, for every first ridge 42 of the plug connector 10, a separate concave bending area 51 of the tool 50 may be provided, in order to enable an especially precise bending of the first blades 33.

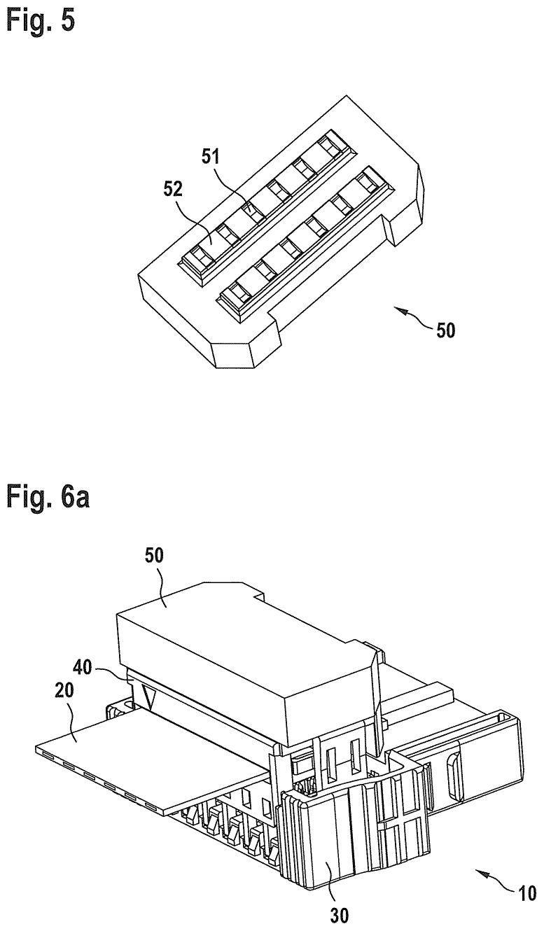

A second exemplary embodiment of the tool 50 according to the invention is shown in FIG. 5. This has a separate bending area 51 for each first blade 33 of the plug connector 10. All bending areas 51 which are intended to engage in one of the two openings 44 of the second housing part 40 are designed as concave recesses in a shared support 52, which protrudes from the main body of the tool 50. During placement of the tool 50 on the second housing part 40, every support 52 engages in one of these openings 44.

In one exemplary embodiment of the assembly method, the assembly steps shown in FIGS. 1a to 3c are carried out first, and one of the tools 50 is then placed on the second housing part 40, in order to bend the first areas 331 of the first blades 33 in such a way that they take on the shape shown in FIGS. 3b and 3c.

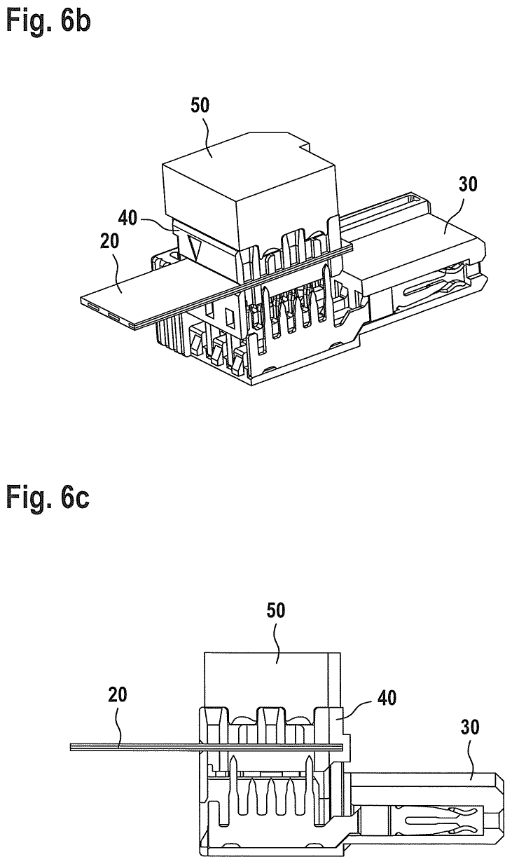

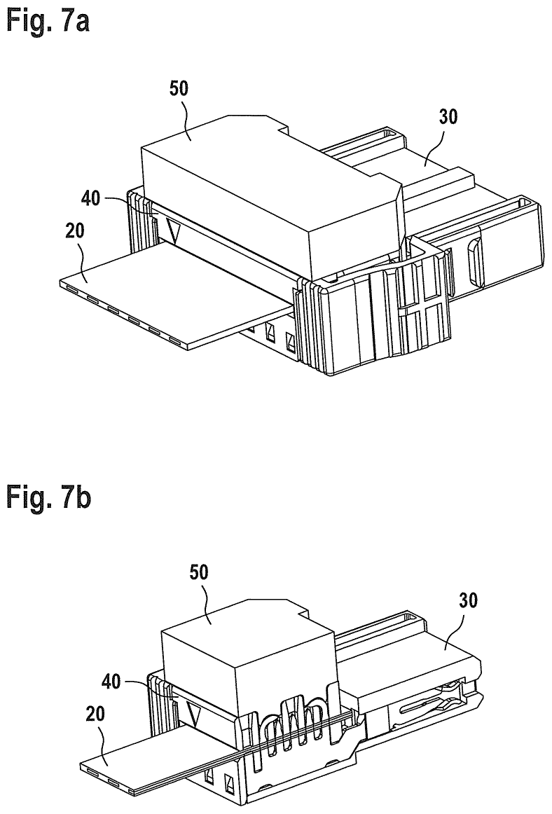

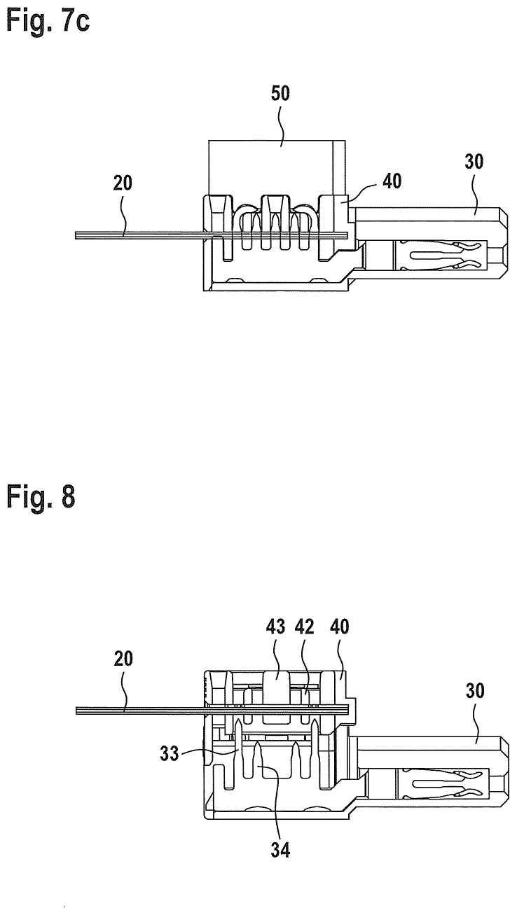

In a second exemplary embodiment of the assembly method, the tool 50 is already placed on the second housing part 40 in the first assembly step or in the second assembly step. In FIGS. 6a to 6c it is shown how the second assembly step proceeds in this case, and in FIGS. 7a to 7c it is shown how the third assembly step proceeds in this case. In the third assembly step, the first areas 331 of the first blade 33 thereby first intersect the conductor foil 20. They then meet on the bending area 51 of the tool 50. While the conductor foil 20 is moved further in the direction of the row 32, and is thereby intersected by the two areas 332 of the first blades 33, and is also successively intersected by the first areas 341 and then by the second areas 342 of the second blades 34, the pressure of the tool 50 exerted on the first areas 331 of the first blades 33 deforms the latter in the direction of their respective first ridges 42, so that a tight fit between the first area 331 of every first blade 33 and its respective first ridge 42 is produced. As shown in FIG. 7b, the first area 331 of every first blade 33 is thereby clamped between its first ridge 42 and a bending area 51 of the tool 50. If the tool 50 is ultimately removed, the assembled state of the plug connector assembly occurs that is shown in FIGS. 3a to 3c.

According to further embodiments, the first housing part 30 may comprise different rows 32 of blades 33, 34, which are configured as a cutting edge. When using another row 32 of blades, the two first ridges 42 and any second ridges 43 are arranged according to the arrangement of the first blades 33 and second blades 34.

Even if it is principally possible to push the housing parts 30, 40 into each other at first and only then to bend the first areas 331, 341 of all the first blades 33, the pushing-in and the bending may be carried out simultaneously. The number of method steps is thus decreased, which simplifies an automation of the method. The simultaneous pushing-in and bending can in particular be achieved in that the tool 50 according to the third aspect of the invention is already engaged with the plug connector 10, before the housing parts 30, 40 are pushed into each other. During the pushing-in, the first blades 33 then first intersect the conductor foil 20, subsequently meet on the bending area 51 of the tool 50 and are bent until the bending process is stopped by the tight fit between first blade 33 and first ridge 42. During the bending process, both housing parts 30, 40 continuously move towards each other, so that potentially available second blades 34, which are shorter than the first blades 33, can intersect the conductor foil 20 during the bending process.

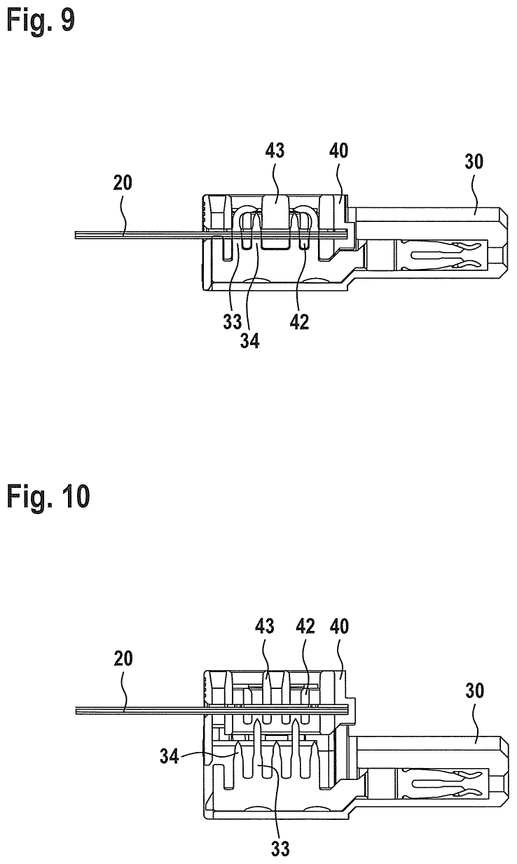

A second embodiment of the plug connector assembly in the second assembly step is shown in FIG. 8. It differs from the plug connector assembly according to the first embodiment in only having two second blades 34 in each row 32. The middle second blade 34 that is neighbored by two further second blades 34 in the first embodiment has been removed. Instead of two second ridges 43 that are each neighbored by two second blades 34 in each row 32 this embodiment comprises one second ridge 43 that is so broad, that it fills the space occupied by the omitted two second ridges 43 and the omitted second blade 34 of the first embodiment, when the two housing parts 30, 40 are pushed together in the third assembly step. This is shown in FIG. 9. As in the first embodiment of the plug connector assembly, the first areas 331 of the first blades 33 are bent in a circular arc by 90° in the direction of their respective first ridge 42, until they come to rest in a tight fit on the curved face of the first ridge 42 and the tips of both first blades 33 point to each other.

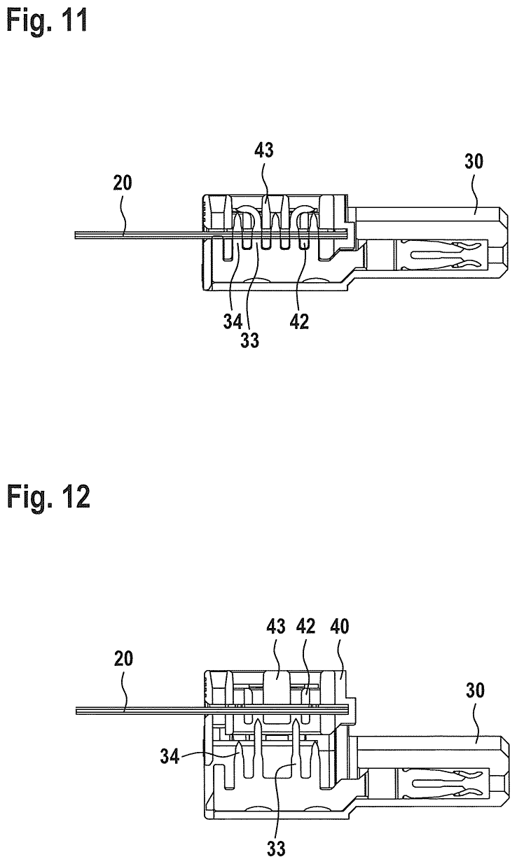

A third embodiment of the plug connector assembly in the second assembly step is shown in FIG. 10. In each row 32, there are two first blades 33 and three second blades 34. Each first blade 33 is arranged between two second blades 34 so that one second blade 34 is arranged between two first blades 34. When the two housing parts 30, 40 are pushed together in the third assembly step, two first ridges 42 each come to rest between a first blade 33 and one of the outer second blades 34. Two second ridges 43 each come to rest between a first blade 33 and the middle second blade 34 during the pushing-in of the housing parts 30, 40. This is shown in FIG. 11. The first areas 331 of the first blades 33 are bent in a circular arc by 90° in the direction of their respective first ridge 42, until they come to rest in a tight fit on the curved face of the first ridge 42 and the tips of both first blades 33 point away from each other.

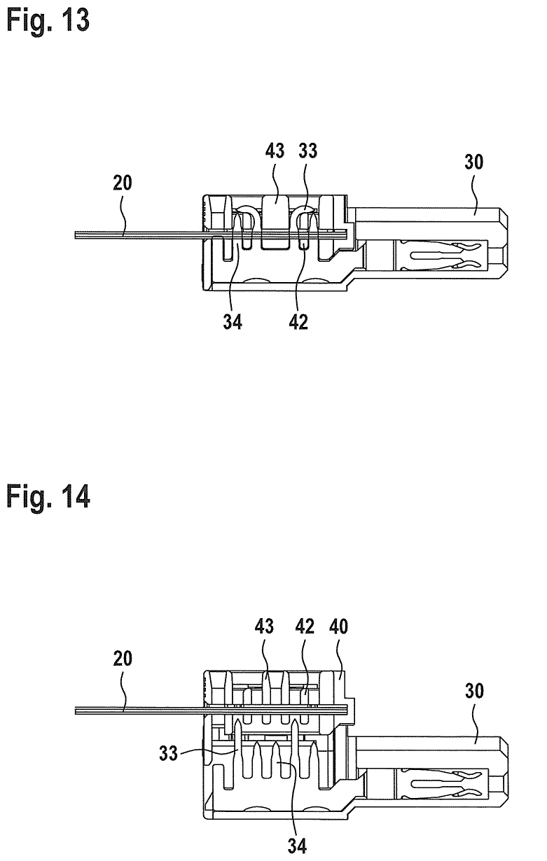

FIG. 12 shows a fourth embodiment of the plug connector assembly in the second assembly step. It differs from the plug connector assembly according to the third embodiment in only having two second blades 34 in each row 32. The middle second blade 34 that is arranged between the first blades 33 in the third embodiment has been removed. Instead of two second ridges 43 that are each neighbored by a first blade 33 and a second blade 34 in each row 32 this embodiment comprises one second ridge 43 that is so broad, that it filles the space occupied by the omitted two second ridges 43 and the omitted second blade 34 of the third embodiment, when the two housing parts 30, 40 are pushed together in the third assembly 15 step. Therefore, it comes into rest between the two first blades 33. This is shown in FIG. 13. As in the third embodiment of the plug connector assembly the first areas 331 of the first blades 33 are bent in a circular arc by 90° in the direction of their respective first ridge 42, until they come to rest in a tight fit on the curved face of the first ridge 42 and the tips of both first blades 33 point away from each other.

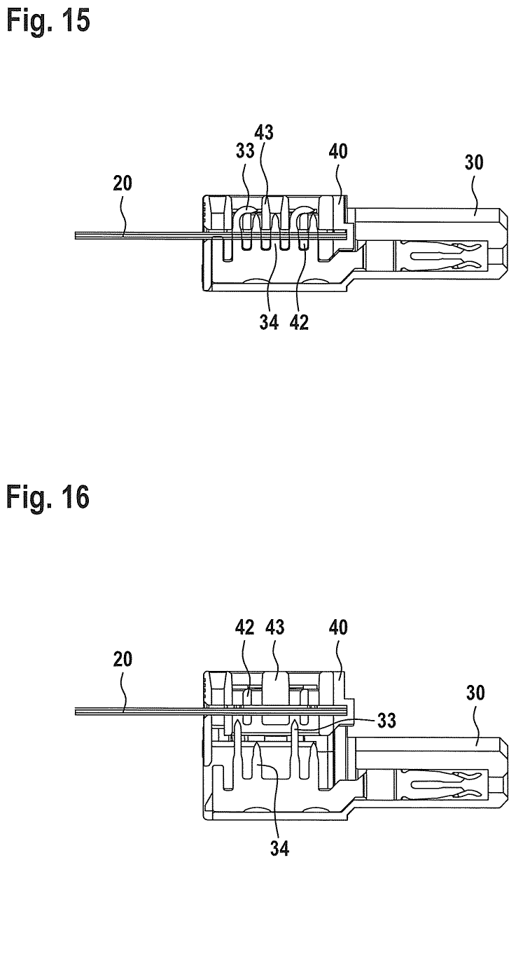

FIG. 14 shows a fifth embodiment of the plug connector assembly in the second assembly step. In each row 32 a first blade 33 is consecutively followed by two second blades 34, one further first blade 33 and one further second blade 34. When the two housing parts 30, 40 are pushed together in the third assembly step, as shown in FIG. 15, a first ridge 42 comes to rest between the first blade 33 at the beginning of the row 32 and the consecutive second blade 34. One second ridge 42 is arranged between the two neighbored second blades 34 and a further second ridge is arranged between the further first blade 33 and the second blade in front of it. A further first ridge comes into rest between this further first blade 33 and the second blade 34 at the end of the row 32. In each of the previous four embodiments, the first ridges 41 are curved in different directions so that the tips of both first blades 33 point to each other or point away from each other. In contrast, the first ridges 41 of the second housing part 40 of the plug connector assembly according to the fifth embodiment are curved in the same direction so that the tips of both first blades 33 point in the same direction after they have been bent in a circular arc by 90° in the direction of their respective first ridge 42.

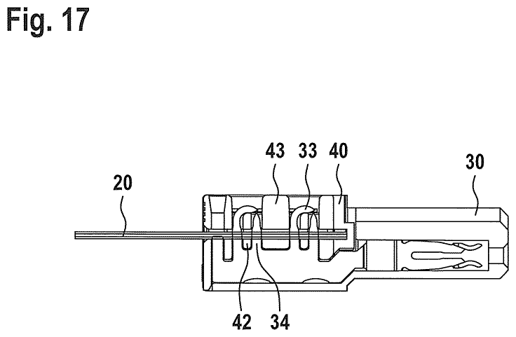

A sixth embodiment of the plug connector assembly in the second assembly step is shown in FIG. 16. It differs from the plug connector assembly according to the fifth embodiment in only having on second blade 34 between the first blades 33 in each row 32. Instead of two second ridges 43, this embodiment comprises only one second ridge 43 that is so broad, that it fills the space occupied by the omitted two second ridges 43 and the omitted second blade 34 of the fourth embodiment, when the two housing parts 30, 40 are pushed together in the third assembly step. Therefore, it comes into rest between a first blade 33 and a second blade 34. This is shown in FIG. 17. As in the fifth embodiment of the plug connector assembly, the first areas 331 of the first blades 33 are bent in a circular arc by 90° in the direction of their respective first ridge 42, until they come to rest in a tight fit on the curved face of the first ridge 42 and the tips of both first blades 33 point in the same direction.

What is claimed is:

1. A plug connector, comprising:
a first housing part having a plug contact element with a plurality of blades that are electrically conductively connected; and
a second housing part having a receiving area receiving a conductor foil, the second housing part has a first ridge pressing the conductor foil in the receiving area in a direction of the blades while the first housing part and the second housing part are pushed into each other, the first ridge engages in a fit with a first blade of the plurality of blades when a first area of the first blade is bent in a direction of the first ridge.

2. The plug connector of claim 1, wherein the first housing part has the first blade and a second blade of the plurality of blades, the first blade is longer than the second blade.

3. The plug connector of claim 2, wherein the first housing part has a row of the plurality of blades, the row includes a pair of first blades and a pair of second blades.

4. The plug connector of claim 2, wherein the first housing part has a row of the plurality of blades, the first blade is one of a plurality of first blades and the second blade is one of a plurality of second blades, the second blades are arranged between the first blades.

5. The plug connector of claim 2, wherein the first ridge is arranged between the first blade and the second blade.

6. The plug connector of claim 1, wherein the second housing part has a second ridge arranged between two of the plurality of blades.

7. The plug connector of claim 6, wherein the second ridge presses the conductor foil arranged in the receiving area in the direction of the blades while the first housing part and the second housing part are pushed into each other.

8. The plug connector of claim 7, wherein the second ridge is arranged between a pair of second blades of the plurality of blades.

9. The plug connector of claim 1, wherein the first area of the first blade has a smaller width than a second area of the first blade.

10. The plug connector of claim 1, wherein the first ridge has a surface curvature.

11. The plug connector of claim 1, wherein the second housing part has an opening above the first ridge on a side that faces away from the first housing part.

12. A plug connector assembly, comprising:
a flexible conductor foil; and
a plug connector including a first housing part having a plug contact element with a plurality of blades that are electrically conductively connected and a second housing part having a receiving area receiving the flexible conductor foil, the second housing part has a first ridge pressing the flexible conductor foil in the receiving area in a direction of the blades while the first housing part and the second housing part are pushed into each other, the first ridge fits with a first blade of the plurality of blades when a first area of the first blade is bent in a direction of the first ridge.

13. The plug connector assembly of claim 12, wherein the first blade is bent in the first area by at least 80°.

14. The plug connector assembly of claim 12, wherein the first blade is bent in a circular arc in the first area.

15. The plug connector assembly of claim 12, wherein a tip of the first blade is arranged above a tip of a second blade of the plurality of blades.

16. A tool for assembling a plug connector, comprising:
a concave bending area engaging in an opening of a plug connector, the concave bending area has a surface curvature corresponding to a surface curvature of a first ridge of the plug connector.

17. The tool of claim 16, wherein the concave bending area is one of a plurality of concave bending areas and the first ridge is one of a plurality of first ridges of the plug connector, each of the concave bending areas corresponds to one of the first ridges.

18. A method for assembling a plug connector, comprising:
providing a first housing part having a plug contact element with a plurality of blades that are electrically conductively connected;
providing a second housing part having a receiving area receiving a conductor foil and a first ridge;
inserting a conductor foil into the receiving area of the second housing part;
pushing the first housing part and the second housing part together, the first ridge presses the conductor foil in a direction of the blades, the conductor foil is intersected by the blades; and
bending a first area of a first blade of the plurality of blades in a direction of the first ridge until the first blade engages in a fit with the first ridge.

19. The method of claim 18, wherein the bending occurs with a tool inserted into an opening of the second housing part, the first blade is bent by a bending area of the tool.

20. The method of claim 18, wherein the pushing and bending steps are carried out simultaneously.
